(19) United States
(12) Patent Application Publication
(10) Pub. No.: US 2008/0257386 A1
(43) Pub. Date: Oct. 23, 2008

(54) Water-Based Cleaning

(75) Inventor: Richard Mark Pashley, Australian Capital Territory (AU)

Correspondence Address: KNOBBE MARTENS OLSON & BEAR LLP, 2040 MAIN STREET, FOURTEENTH FLOOR, IRVINE, CA, 92614, US

(73) Assignee: THE AUSTRALIAN NATIONAL UNIVERSITY, Australian Capital Territory (AU)

(21) Appl. No.: 10/583,815

(22) PCT Filed: Dec. 22, 2004
(86) PCT No.: PCT/AU2004/001808

§ 371 Date: Jun. 25, 2008

(30) Foreign Application Priority Data
Dec. 23, 2003 (AU) 2003907176
Aug. 19, 2004 (AU) 2004904755

(51) Int. Cl. B08B 3/04; B08B 3/08

(52) U.S. Cl. 134/26; 134/42; 134/32; 134/34; 134/198; 134/184; 134/115 R; 134/94.1

(57) ABSTRACT

A method of cleaning a surface, comprising applying de-gassed water (containing no more than 1 ppm gas) to the surface to disperse or dissolve dirt on the surface in the water. The method may also comprise dissolving hydrophobic dirt on the surface using a non-aqueous solvent, and dispersing the non-aqueous solvent and dissolved hydrophobic dirt in the de-gassed water. The non-aqueous solvent may itself contain low levels of dissolved gas, for example no more than 10 ppm. Apparatus for cleaning a surface is also disclosed.

### TECHNICAL FIELD

The present invention relates to the cleaning of surfaces, and is particularly concerned with cleaning using water, optionally with other cleaning agents, for example in combination with other fluids.

### BACKGROUND

The fundamental reason why oil molecules do not dissolve in water is because hydrocarbon (and fluorocarbon, chloro-hydrocarbon and silicone) molecules are non-polar and so cannot replace the strong water-water bonds. These need to be broken to incorporate the solute molecule, with equally strong water-solute bonds. For hydrocarbon and the like molecules to be dissolved in water, the water molecules have to be forced apart so that they can then form ice-like clusters around the hydrocarbon. The larger the hydrocarbon molecule, the more water molecules need to be disrupted, and so the lower the solubility. For example, heptane is slightly soluble in water but the larger molecule dodecane is almost completely insoluble. Because this disruption of water is unfavoured, hydrocarbon and other oil molecules in water will experience a short-range attractive force, caused by the favoured release of any disrupted water molecules back into their bulk state. The oil molecules are therefore forced together and ‘bond’ in water. This bond is called the hydrophobic bond (1). The same factors explain why polar materials, such as sugars, alcohol and salts, are readily soluble in water, since these solutes interact favourably with the surrounding water molecules.

However, molecular solutions are not the only state for mixing phases. In nature many insoluble materials are ‘dispersed’ in water in a finely divided form, as a colloidal solution. Such insoluble materials include, for example, biological cells in blood, clay particles in river water and oil/water emulsions. In each case, microscopic particles of one phase are stabilized in water, usually by repulsive electrostatic forces, which can overcome the ubiquitous attractive van der Waals force (2). Over twenty years ago another important attractive force was discovered, acting between hydrophobic particles in water, called the long range hydrophobic interaction (3). The unexpected strength and range of this force has made a proper theoretical explanation difficult, but it has been suggested that the force is a cause of instability of hydrophobic colloids in water (4). In the last few years experimental studies have provided evidence in support of an explanation related to the presence of dissolved gas in water (4,5,6). Even in some early studies (7) there was experimental evidence for the formation of vapour- or gas-filled bridges created as two hydrophobic surfaces were separated in water. Further evidence for this effect was obtained recently in a study of the effect of complete de-gassing on the dispersion of oil droplets (and fine Teflon powder) in water (8,9). De-gassing appears to facilitate the dispersion of oils and finely divided hydrophobic solids, without the need for common dispersants such as polymers and surfactants. However, gassing levels do not appear to affect the stability of the emulsions, once formed (8, 9,10).

Water-based cleaning is effective because hydrophilic polar solutes, such as sugar and salt (ie ‘dirt’), dissolve readily in water, which is a good general purpose solvent. However, hydrophobic dirt, such as charcoal, grease and oil, is not water soluble at normal temperatures. To overcome this problem, these materials are commonly dispersed in water via a combination of mechanical agitation (during conventional washing) and by the use of added surface active solutes, such as soaps or detergents (surfactants), which coat hydrophobic materials in water. Surfactant molecules adsorb onto hydrophobic surfaces in water. This makes them hydrophilic, which enhances their dispersion (not solubility) in water, so that they can be carried away in the aqueous phase during cleaning. Mechanical agitation is a vital component of conventional cleaning. Liquid hydrocarbon oils can also be absorbed into micelles formed by these surfactants, facilitating cleaning.

### SUMMARY OF THE INVENTION

It would be highly advantageous to be able to remove hydrophobic dirt from articles and surfaces using water without any or with reduced amounts of surfactants and other dispersants.

According to the present invention, there is provided a method of cleaning a surface, which comprises applying water containing no more than 1 ppm gas to the surface to disperse or dissolve dirt on the surface in the water. The water containing the dispersed or dissolved dirt may then be rinsed away.

Also according to the present invention, there is provided apparatus for cleaning a surface, which comprises a source of water containing no more than 1 ppm gas and a dispenser for applying the de-gassed water to the surface.

The relatively low level of dissolved gas normally present in water at room temperature, of about 1 mM (or about 20 mL of gas per litre, which is equivalent to about 30 ppm) suggests that its influence should be limited to processes involving relatively low (hydrophobic) surface areas. Thus, for micellar (11) solutions and microemulsions (12), in which the number of dissolved gas molecules is small relative to the interfacial area available per unit volume of mixture, reducing the level of gas appears not to influence the properties of these systems.

By comparison, the breakaway of oil droplets from a macroscopic oil/water interface, and the dispersion of finely divided hydrophobic particles, offers a low surface area process which it has been found can be influenced by a reduction of the normal relatively low level of dissolved gas. This is even more the case when dissolved gas molecules accumulate next to oil-water (and hydrophobic particle/water) interfaces. This is believed to be because dissolved oxygen and nitrogen (dissolved carbon dioxide is at the much lower level of about 10 μM) molecules, like hydrocarbons, will disrupt adjacent water molecules because of their non-polar nature and weak van der Waals interaction with water. The presence of macroscopic, hydrophobic surfaces ought to attract these dissolved gas molecules from the water phase and this accumulation may also be aided by the increased solubility of gas in hydrocarbon oils, which can be an order of magnitude higher than water. As described above the presence of this layer of dissolved gas, in a thin film, which is placed under a negative (suction) pressure during droplet/particle breakaway, may cause gas cavities to nucleate, which will create a bridge between the surfaces and oppose droplet release. Vapour cavitation may also be expected for the separation of hydrophobic surfaces in water (13). The precise detail of this process is not known, but cavity bridging between the surfaces and an enhanced van der Waals attraction between the surfaces will both act to hold the surfaces together, thereby reducing the dispersion of the hydrophobic material in the water. Whatever the mechanism, reducing the amount of dissolved gas in the water has been found to reduce the forces holding the oil and other hydrophobic particles (eg oil, grease and charcoal, and herein separately or together referred to as “hydrophobic dirt”) to the surface and to allow the hydrophobic dirt to be released into the water.

Water containing reduced amounts of dissolved gas, to a level of no more than 1 ppm gas, is hereinafter referred to as “de-gassed water”.

Using de-gassed water to aid in the dispersive removal of hydrophobic (solid or liquid) dirt represents an entirely different approach compared to cleaning with detergents. As described above, the main detergent action is to coat hydrophobic surfaces to make them hydrophilic, and hence readily dispersible in water. However, in both cases the crucial step will involve the separation of two surfaces from intimate molecular contact and the exposure of a least one hydrophobic surface to water.

In detergent cleaning, hydrophobic materials usually become charged due to detergent adsorption and this helps to stabilise them. However, it has recently been demonstrated that hydrophobic colloids naturally develop a significant charge in water, which also helps to stabilise them in water (14). In detergent cleaning, the surfactant-coated hydrophobic dirt is thermodynamically more stable in water than hydrophobic dirt dispersed under de-gassed conditions. However, we have demonstrated that, although not thermodynamically stable in water, hydrocarbon oil droplets that are dispersed using de-gassed conditions do not coalesce and will remain in a meta-stable state of more than sufficient duration to be effective in cleaning.

By “applying water” as used herein is meant any arrangement by which the de-gassed water can be caused to act on the surface in the method or apparatus of the invention. Where the surface to be cleaned is on an article, this includes introducing an article to a container of the de-gassed water (or de-gassed water to a container containing the article) in which the article may be left for a period of time to “soak”, with or without agitation. It also includes spraying the surface with the de-gassed water using a high or low pressure spray dispenser, preferably using an airless pump or other spray system, and merely causing the de-gassed water to relatively flow over the surface. It will be appreciated that the surface may effectively be three-dimensional, because, for example, it is part of a woven or knitted fabric or is porous.

The invention described herein is analogous in some respects to normal cleaning, except that the removal of hydrophobic dirt is achieved at least primarily, or in some embodiments at least in part, by the use of de-gassed water. The dispersion of hydrophobic dirt by the de-gassed water, including the time taken for the cleaning, is advantageously enhanced by the use of mechanical action, that is agitation. This mechanical action can be in the form of, for example, multiple streams of de-gassed water, preferably fine jets, directed at high or low pressure onto a dirty surface, or any conventional mechanical action used in a cleaning process. Mechanical action combined with the dispersive power of de-gassed water will disperse hydrophobic dirt, while hydrophilic, polar, dirt (eg salts, sugars) will be dissolved in the normal manner. Thus, soluble dirt is dissolved, while hydrophobic dirt is dispersed and all of the dirt may then be rinsed away. Long term stability of the dispersion of dirt in water is not required in cleaning, and subsequent de-stabilisation could actually be useful.

However, as with conventional cleaning, the addition of hydrophilic, polymeric stabilisers, such as sodium carboxymethylcellulose, may also be used to enhance the longer term dispersive power of de-gassed water, preventing the re-deposition of the dirt.

While some enhanced cleaning effect using de-gassed water may be achieved using water containing more than 1 ppm dissolved gas (but less than the usual level of dissolved gas), it is believed that the effect will not be significant and that about 1 ppm is therefore a practical limit. Preferably, the water contains no more than about 0.9 ppm gas, equating to about 97% of the dissolved gases present in the source water being removed. The cleaning action of the de-gassed water will be enhanced at higher levels of de-gassing, and more preferably the water contains no more than about 3 ppb gas, most preferably no more than about 0.3 ppb gas, equating to about 99.99% and about 99.999%, respectively, of the dissolved gases being removed from the source water. The source water may be distilled water, tap water or, for some purposes, even recycled cleaning water.

The de-gassing of the water can be achieved by any suitable vacuum pump with a nitrogen trap. In one embodiment, de-gassing is achieved by repeated freezing and pumping using an efficient mechanical pump. Once the space above the frozen water is out-gassed, to typically better than a mTorr, a Teflon tap may be closed and the water warmed to room temperature so that remaining dissolved gases are pulled into the space above the liquid by the vacuum. This may be repeated, for example, up to four or five times to ensure almost complete removal of the dissolved gas. When connected to a separate vacuum line of substantially greater volume, the mechanical pump has been found to achieve pressures down to 20-40 μTorr. Evacuation of the water to lower than a mTorr corresponds to greater than about 99.999% removal of the dissolved gas. Evacuation of the water to lower than about 20 Torr corresponds to greater than about 97% removal of dissolved gas, and evacuation of the water to lower than about 20 milliTorr corresponds to greater than about 99.99% removal of dissolved gas.

Alternatively, the water may be de-gassed by any other suitable method. For example, water can be de-gassed to the required level in a vacuum tower or by using a hydrophobic porous membrane (15, 16).

The de-gassing of the water may be part of the cleaning process. Alternatively, the cleaning process may conveniently use a stored source of the de-gassed water.

The cleaning may be performed at any temperature at which the water is liquid, between (not including) 0° C. and 100° C. at normal pressure, but is conveniently performed at room or ambient temperature.

The potential advantages of a detergent-free cleaning system are enormous in terms of cost and environmental savings, and might be of particular value for specialist applications. Some examples follow.

Micro-electronic circuits currently have to be cleaned with relatively toxic solvents that are expensive and have to be recycled. De-gassed water can be sprayed onto delicate electronic devices without the disadvantage of leaving residual detergent coatings. The washings can be discarded.

Automobile surfaces, and other surfaces, may be cleaned using a tube held close to the contours of the surface and moved across the surface. Holes in the tube produce fine jets or streams of de-gassed water, which hit the surface and clean via dissolution and dispersion.

Household clothes' washing systems may be developed using agitation of clothes in a basin with fine jets or streams of de-gassed water covering all articles of clothing over the period of agitation. Clothes and other articles may also be left to soak in a container of de-gassed water, optionally with agitation of the articles.

Vegetables are often cleaned using a water-based flotation process. De-gassed spraying could offer a detergent-free alternative.

The rate of diffusion of air into de-gassed water is remarkably slow and so should not present a problem for spray processes, in which the de-gassed water is exposed to air for only a brief length of time (ie. seconds). Theoretically, at room temperature it takes about 10 days to reach dissolved gas saturation to a depth of lcm in quiescent, de-gassed water. However, external factors, including vibration and convection, may accelerate the diffusion process.

Advantageously, the cleaning process using de-gassed water may be preceded by first at least partly dissolving hydrophobic dirt on the surface using a non-aqueous solvent. Preferably, the non-aqueous solvent, with any dissolved hydrophobic dirt, is discarded or otherwise separated from the surface prior to applying the de-gassed water. Alternatively, the non-aqueous solvent may be applied to the surface at the same time as the de-gassed water. Both the dissolved hydrophobic dirt and the non-aqueous solvent, as well as any undissolved hydrophobic dirt, are dispersed by the de-gassed water.

Thus, this two-part cleaning process is based on the solvent properties of non-aqueous solvent for hydrophobic dirt and the solvent properties of water for polar dirt, combined with the enhanced dispersive powers of de-gassed water. Hydrophobic dirt (eg oils, grease) will at least partly dissolve in the solvent in the first part of the cleaning process and hydrophilic, polar, dirt (eg salts, sugars) will dissolve in the water wash. In addition, the solvent, or any residual solvent if the body of it has been relatively separated from the surface prior to the water wash, will be readily dispersed in the de-gassed water, enabling the solvent and dirt to be completely removed. The solvent and water can be subsequently phase separated and recycled after suitable cleaning. Using de-gassed water to remove solvent containing dissolved hydrophobic dirt represents an entirely different approach to cleaning without detergents. This cleaning process will be of particular value in applications where detergent residues are not acceptable, such as in the preparation of silicon wafers and in the cleaning of surgical equipment.

The non-aqueous solvent is hydrophobic. Possible non-aqueous solvents include hydrocarbons, fluorocarbons, chloro-hydrocarbons and silicone liquids. Some examples are dodecane, squalene, hexamethyldisiloxane and perfluorohexane. These examples are essentially totally insoluble in water, and there is a preferred parameter for the non-aqueous solvent. However, it has been found that a non-aqueous solvent having a small degree of solubility in water may be acceptable. One example of such a material is hexane.

The non-aqueous solvent may be applied to the surface to be cleaned by any of the means described with reference to the de-gassed water.

In a most preferred embodiment of the two-part cleaning process, the non-aqueous solvent is also de-gassed to enhance the dispersion of the non-aqueous solvent in the de-gassed water. Thus, preferably, the non-aqueous solvent contains no more than about 10 ppm dissolved gas.

Gases are generally more soluble in non-aqueous solvents than in water, under the same conditions, and 10 ppm dissolved gas in the non-aqueous solvent equates approximately to 97% of the dissolved gas in the source solvent being removed.

More preferably, the non-aqueous solvent contains no more than about 1 ppm gas. The action of the de-gassed non-aqueous solvent may be enhanced at lower levels of dissolved gas, for example at no more than about 0.3 ppm, most preferably no more than about 3 ppb or even 0.3 ppb, dissolved gas.

De-gassing of the non-aqueous solvent may be performed by the same multiple freeze/thaw/pumping cycles as described above for the de-gassed water. Alternatively, the non-aqueous solvent may be de-gassed in a vacuum tower. The de-gassing of the non-aqueous solvent may be part of the cleaning process. Alternatively, the two-part cleaning process may conveniently use a stored source of the de-gassed solvent.

### BRIEF DESCRIPTION OF THE DRAWINGS

Aspects of the present invention will now be described in detail, by way of example only, with reference to the accompanying drawings, in which:

FIG. 1 is graph showing percentage of de-gassing against vacuum pressure in a mechanical pump with a liquid nitrogen trap;

FIG. 2 is a graph illustrating the turbidity of normal gassed water and of de-gassed water after shaking in a container contaminated with dodecane as described in Example 2;

FIG. 3 is a graph illustrating the turbidity of water washings produced on washing hexamethyldisiloxane from Pyrex glassware as described in Example 3;

FIG. 4 is a graph illustrating the turbidity of water washings produced on washing perfluorohexane from Pyrex glassware as described in Example 4; and

FIG. 5 is a schematic representation of one form of cleaning apparatus.

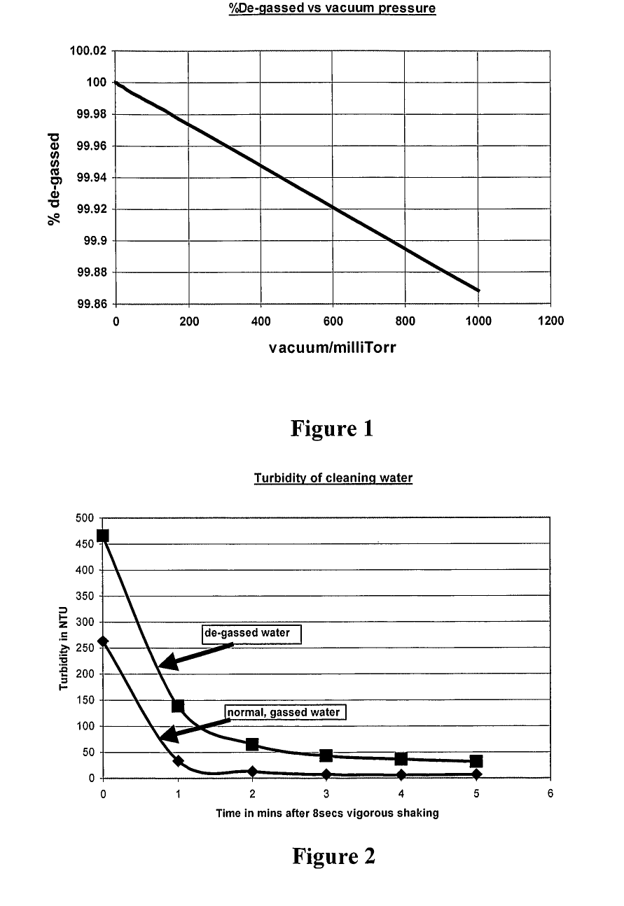

FIG. 1 illustrates the vacuum required for a degree of de-gassing between 99.87% and 99.999%, if it is assumed that the final pressure achieved on several cycles of freeze/thaw/pumping is given by the pressure in equilibrium with the final frozen liquid, which on being melted does not give any visible bubbling/out-gassing.

### EXAMPLE 1

Distilled water was produced from tap water via a sequential process of coarse filtration, activated charcoal filtration, reverse osmosis filtration and, finally, distillation into a glass storage vessel housed in a laminar flow, clean air cabinet. All the chemicals used were of the purest grade available and used as purchased.

Samples of clean, distilled water were out-gassed by a process of repeated freezing in liquid nitrogen, followed by pumping down to a pressure of 0.01 mbar and then melting in a sealed tube. The dissolved gas produced on each melting cycle was removed on re-freezing. Although this process was carried out five times, typically no further de-gassing on melting was observed after 3-4 cycles. The vacuum pressure of 0.01 mbar corresponds to a de-gassing level of about 99.999% or about 0.3 ppb gas in the water.

This water was then used to clean strips of standard filter paper having finely divided activated charcoal rubbed into their surface to produce a uniform blackened region, by placing each strip into a respective test tube and pouring the de-gassed water into the tube. The cleaning effect of the de-gassed water was compared with that of distilled water that had not been de-gassed. The non de-gassed distilled water was at equilibrium with the environment and was estimated to contain about 30 ppm dissolved gas.

In a first test, the same volume of normal and de-gassed water, respectively, was simply poured onto the dirty paper in the test tubes.

In a second test, the same volume of normal and de-gassed water, was respectively, poured onto the dirty paper in the test tubes and then the tubes with the strips immersed in the water were vigorously shaken by hand for 8 seconds.

In both of these rudimentary, non-optimum, cleaning tests it was immediately obvious from visual examination that the de-gassed water removed substantially greater amounts of the activated charcoal. In the first test, with no agitation, during pouring of the de-gassed water it was clear that some areas were being cleaned and a significant amount of fine carbon was carried to the surface. By comparison, in the second test, on shaking the tube, the de-gassed water produced significantly more charcoal sediment and a more cloudy solution. Photographic evidence was taken of these results.

It is interesting that these simple experiments clearly indicate that de-gassed water does have an improved cleaning effect because the substrate in this case, paper, is hydrophilic and finely divided activated charcoal is, in any case, relatively easily dispersed in normal, gassed water.

However, further studies indicate that the buoyancy of porous powders, such as activated charcoal, may be a factor in determining the ability of gassed or de-gassed water to ‘float’ dirt off a surface and hence clean. Caution is therefore required in interpreting these observations. In addition, most hydrophobic solids have water contact angles close to but less than 90° and so cavitation effects are somewhat dependent on surface heterogeneity. Hydrophobic liquids are not susceptible to these effects and hence give an unambiguous demonstration of the effect of de-gassing, as will be seen in the following examples.

### EXAMPLE 2

In this example, a small amount of the hydrocarbon oil dodecane was left in the base of each of two glass tubes. The same volume of normal water that had not been de-gassed and water that had been de-gassed in the manner described in Example 1 was poured into each tube and the tubes were shaken vigorously for 8 seconds.

FIG. 2 shows the turbidity of the water in each tube five minutes after this procedure. The results clearly demonstrate that de-gassed water is more effective at removing residual oil ‘dirt’ on glass. Similar results were achieved with the hydrocarbon oil squalene. These results are particularly interesting and important because the oil was completely equilibrated with the atmosphere prior to cleaning and hence contained dissolved gas at a significantly higher level (approximately ten times) than normal (non de-gassed) water. Any diffusion of dissolved gas into the water from the oil did not appear to prevent the cleaning enhancement of de-gassed water. Presumably this is rate dependent and rapid cleaning will favour the enhancement using de-gassed water.

Further cleaning experiments were carried out on hexamethyldisiloxane (Example 3) and perfluorohexane (Example 4) in Pyrex glassware. Typically a small, known amount of the non-aqueous solvent was poured into the bottom of a glass tube and either ordinary distilled water or de-gassed water was introduced, the tube sealed and vigorously shaken (typically for 8 secs). The resultant water phase turbidity was measured over time. In some experiments the non-aqueous solvent was also de-gassed. All water transfers were carried out in laminar filtered air cabinets.

In Examples 3 and 4, the de-gassed water was prepared in the manner described in Example 1, and the de-gassed non-aqueous solvent was prepared by the same procedure.

### EXAMPLE 3

This example compares the embodiments of the cleaning process of the invention using both de-gassed water and de-gassed non-aqueous solvent, hexamethyldisiloxane and using non de-gassed solvent but de-gassed water, with cleaning using non de-gassed water and non de-gassed solvent.

In these rudimentary cleaning experiments with hexamethyldisiloxane, it was clear from visual examination that the de-gassed water removed the gassed, non-aqueous solvent more effectively than distilled water. However, de-gassing the solvent as well as the water produces a substantial enhancement in dispersion. In order to quantify these observations, measurements were obtained for the turbidity of water washings produced on washing hexamethyldisiloxane from Pyrex glassware.

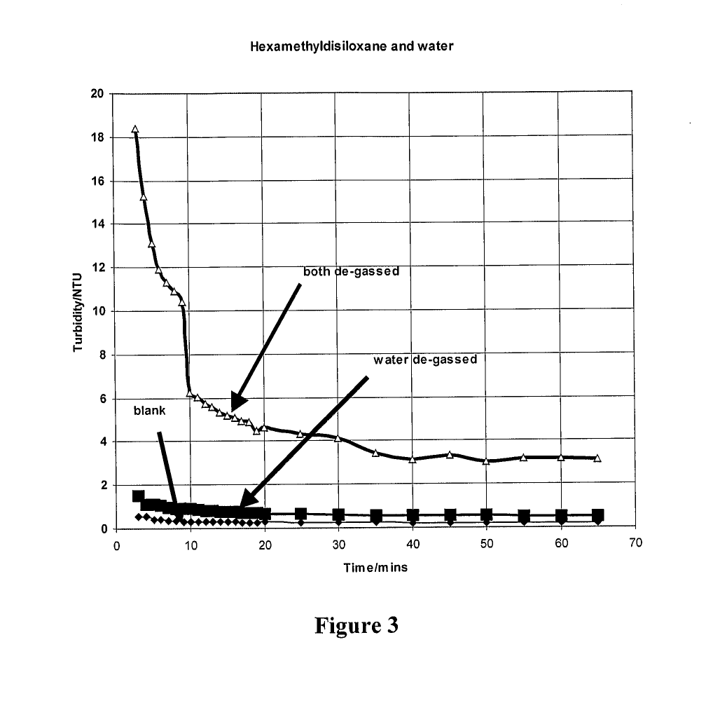

FIG. 3 illustrates the turbidity measurements over 65 minutes, with “blank” showing the experiment in which neither the water nor the solvent were de-gassed.

### EXAMPLE 4

This example illustrates the embodiment of the cleaning process of the invention using both de-gassed water and de-gassed perfluorohexane and compares it with cleaning using non de-gassed water and non de-gassed solvent. Again, the performance was assessed by using turbidity measurements. The comparison was run twice.

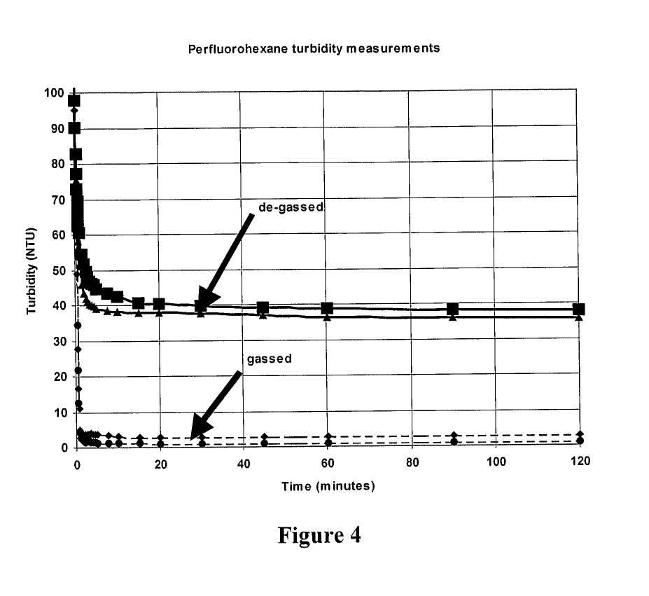

The results are shown in the graph of FIG. 4, from the turbidity measurements in which it is clear that the ability of rinsing water to disperse the perfluorohexane, and hence clean, is significantly enhanced by de-gassing the water and the solvent. Even within a minute after shaking, the non de-gassed liquids were almost completely phase separated, whereas the de-gassed liquids formed a very stable emulsion, as evidenced by the upper pair of almost horizontal curves (after about 5 minutes) in FIG. 4. Photographic evidence was taken of these results. Washing the Pyrex tube with de-gassed water after the tube has been emptied completely removed the (de-gassed) fluorocarbon solvent.

The results presented in Examples 3 and 4 indicate that a two-stage cleaning system of de-gassed solvent followed by de-gassed water rinsing may offer an even more effective alternative to detergent based cleaning than merely using de-gassed water. The system may be particularly useful for applications where detergent residues need to be avoided, for example, in silicon wafer manufacture and surgical equipment cleaning. De-gassing of the oil appears to have a substantial effect on the inhibition of cavity formation, and hence supports oil dispersion. This indicates that, in the absence of degassing of the oil, the higher solubility of gases in the oil phase provides a reservoir of gas which may diffuse into the aqueous phase, enhancing the cavitation process as droplets start to separate. Removal of this dissolved gas from the oil allows much more effective droplet dispersion.

In the practice of the cleaning process, at least some hydrophobic dirt present on the surface to be cleaned will be dissolved in the non-aqueous solvent, to be dispersed with the solvent in the de-gassed water. Any polar dirt on the surface will be dissolved in the de-gassed water.

### EXAMPLE 5

In this example, the two part cleaning process using de-gassed dodecane solvent and de-gassed water (samples 8 to 15) was compared with washing in water containing a surfactant (samples 1 to 7). The comparison was conducted using steel screws coated in Vaseline™ petroleum grease. The tests are described below, and results are summarised in Table 1.

Cleaning of Petroleum Grease from Steel Screws by Surfactant Washing:

10 ml of 0.1M sodium dodecyl sulphate was shaken for 10 seconds in a test tube with a screw dirtied with a coating of petroleum grease. The surfactant solution was poured away and replaced with 25 ml distilled water and the tube was then shaken again for a further 10 seconds. The rinsing water was poured away, the residual foam rinsed from the screw with a few drops of distilled water, and the screw dried (either by nitrogen gas or by time exposure to the atmosphere in a laminar flow cabinet) and weighed. The test was repeated a further six times.

Cleaning of Petroleum Grease from Steel Screws by Two Stage Washing:

10 ml of dodecane containing about 10 ppb dissolved gas was shaken as above with the dirtied screw in a test tube for 10 seconds. The dodecane was poured away and the screw and tube were rinsed by shaking with 25 ml distilled water containing about 1 ppb dissolved gas. This was then poured away, and the screw was dried, again either by nitrogen gas or by evaporation, and weighed. If a result seemed aberrant the head of the screw was checked for water and, if water was left, the screw was dried and reweighed. The test was repeated a further seven times.

TABLE 1

| | Cleaning | Screw: initial | Screw: dirty | Screw: final |
|---|---|---|---|---|
| Sample | Method | weight/g | weight/g | weight/g |
| 1 | SDS* | 0.3974 | 0.4036 | 0.4038 |
| 2 | SDS | 0.3974 | 0.4051 | 0.4049 |
| 3 | SDS | 0.3968 | 0.4044 | 0.4045 |
| 4 | SDS | 0.3974 | 0.4024 | 0.4022 |
| 5 | SDS | 0.3975 | 0.4045 | 0.4034 |
| 6 | SDS | 0.3973 | 0.4032 | 0.4026 |
| 7 | SDS | 0.3972 | 0.4025 | 0.4022 |
| 8 | Degassed | 0.3976 | 0.4012 | 0.3985 |
| | | | | (not dried |
| | | | | completely) |
| 9 | Degassed | 0.3975 | 0.4049 | 0.3974 |
| 10 | Degassed | 0.3975 | 0.4052 | 0.3974 |
| 11 | Degassed | 0.3975 | 0.4040 | 0.3974 |
| 12 | Degassed | 0.3983 | 0.4037 | 0.3978 |
| 13 | Degassed | 0.3979 | 0.4045 | 0.3979 |
| 14 | Degassed | 0.3974 | 0.4026 | 0.3974 |
| 15 | Degassed | 0.3975 | 0.4042 | 0.3976 |

*SDS = sodium dodecyl sulphate

These results clearly demonstrate that persistent and robust hydrocarbon grease cannot be easily removed by detergents but can be removed entirely by the two part de-gassed water/solvent system.

### COMPARATIVE EXAMPLE 1

This comparative example further illustrates the problem of residual surfactant monolayer coatings in detergent cleaning, a problem that was highlighted in Example 5.

Several glass plates were cleaned using a plasma cleaner and found to be completely hydrophilic by testing with a water droplet, which was found to rapidly spread over the cleaned glass plates. The surface of glass contains a high density of silanol or hydroxyl groups which strongly hydrogen bond to adjacent water molecules. This surface is almost identical to that of clean silicon wafers. These plates were then immersed in mM aqueous solutions of the cationic detergent cetyltrimethylammonium bromide (CTAB). This detergent was found to adsorb onto the surface of glass making the glass hydrophobic. This is expected for negatively charged surfaces like silicon, glass and mica because the CTAB ionizes to give CTA+ ions. This type of adsorption is common and produces a robust mono-layer coating.

The hydrophobic mono-layer coating of CTAB on glass could not be removed even by repeated washing in distilled water. In addition, the layer could not be removed by repeated rinsing in dodecane. These experiments demonstrate that the use of some detergents in cleaning can lead to residues which are very difficult to remove.

Another common example is the cleaning of sapphire or alumina using common soap. The negatively charged carboxylate group in soap chemically bonds to the positively charged alumina surface. Once again the adsorbed mono-layer cannot be removed by simple water or solvent washing. It will be appreciated that an alumina surface is closely equivalent to an aluminium surface that has been exposed to the atmosphere.

Residual mono-layers will create problems in nano-technology devices, invasive surgical equipment and solid state circuitry. The two part cleaning system described above has the advantage that no residual mono-layers are left on the surface being cleaned.

### EXAMPLE 6

Several glass slides were cleaned by exposure to a plasma reactor in low vapour pressure water. These slides were then completely hydrophilic, with water droplets wetting the surface with an estimated droplet contact angle close to 0°. A thin coating of Vaseline™ petroleum grease, about 0.1 mm thick, was then applied to each clean glass slide. Water droplets placed on the coated slides did not wet the surface and typically had a contact angle of about 100°. The contact angle made by a water droplet on a substrate is an extremely sensitive measure of the hydrophilic or hydrophobic nature of the surface molecular layer. This angle may be used to measure the degree of hydrophobicity of a substrate and may also be used as a measure of surface coating.

The coated slides were then washed in dodecane containing about 10 ppb dissolved gas followed by rinsing in water containing about 1 ppb dissolved gas. The de-gassed dodecane readily dissolved the grease and was poured away prior to rinsing, and it was clear that the de-gassed water rinsing readily removed residual solvent. Once rinsed with water the visibly clean glass plates were dried uider a flow of nitrogen gas and a water droplet again placed on the dry, cleaned glass surface. In each experiment it was clear that the water droplet completely wetted the glass with a contact angle close to zero. The presence of even 1% of a residual mono-layer coating of grease would have prevented wetting and significantly increased the observed contact angle. These results clearly demonstrate that the two-stage cleaning process can completely remove even tenacious contaminants down to sub-molecular surface layers. It will also be apparent that the water contact angles may be used to determine the degree of cleanliness achieved by the method of the invention.

### EXAMPLE 7

The dispersion or cleaning power of de-gassed water was tested for a hydrophobic organic powdered ‘dirt’. The dirt was griseofulrin. The same amount of the dirt and the same amount of water were placed in two glass tubes and vigorously shaken for the same length of time. De-gassed water in one of the tubes clearly dispersed the hydrophobic dirt much better than the normal, gassed water in the other. The de-gassed water contained from about 0.3 to 1 ppb dissolved gas, while the normal water contained 30 ppm dissolved gas. Photographic evidence was taken of these results.

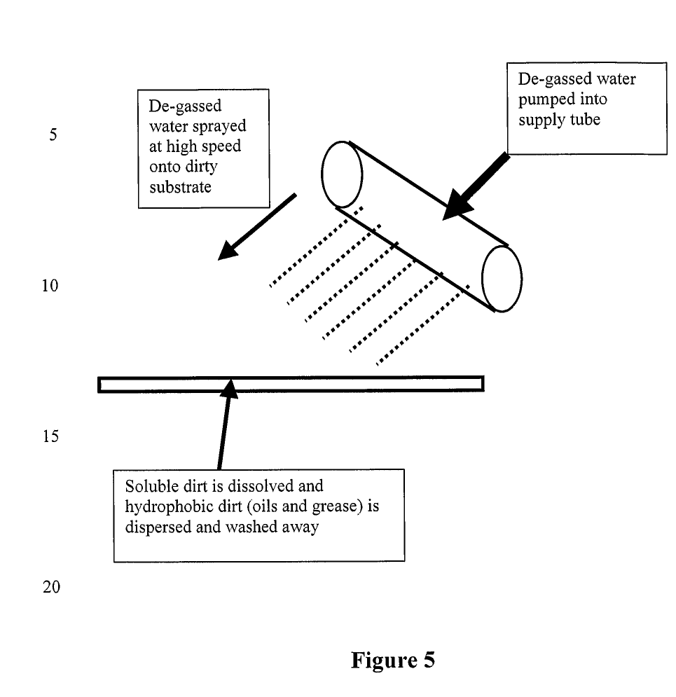

It will be appreciated that de-gassed water will re-equilibrate on exposure to the atmosphere, causing the level of dissolved gasses to increase. Therefore, the time of exposure of the de-gassed water to the atmosphere prior to dispersion is advantageously minimised. A suggested cleaning system is illustrated in FIG. 5. In the cleaning method of the invention, it will be preferred to both reduce exposure time and supply mechanical action to aid dispersion. In the case illustrated in FIG. 5, the mechanical action is supplied as low pressure liquid spray and momentum. The sprayed liquid may be only de-gassed water. However, since it appears that de-gassed oil or other non-aqueous solvent is more effectively dispersed by de-gassed water than gassed non-aqueous solvent, sequential spray cleaning based on de-gassed non-aqueous solvent rapidly followed by de-gassed water rinsing offers an effective detergent-free cleaning solution. The de-gassed non-aqueous solvent could be a hydrocarbon, fluorocarbon, chloro-hydrocarbon or silicone liquid. This type of system offers effective detergent-free cleaning which should disperse and remove all hydrophobic and hydrophilic forms of dirt.

It is to be noted that gas contents in liquids at the parts per billion level and below are very difficult to measure. In the present instance they have been estimated from the de-gassing vacuum levels on the basis of an assumption that there is a linear relationship between the two at these levels.

Those skilled in the art will appreciate that the invention described herein is susceptible to variations and modifications other than those specifically described. It is to be understood that the invention includes all such variations and modifications which fall within its spirit and scope. The invention also includes all the steps and features referred to or indicated in this specification, individually or collectively, and any and all combinations of any two or more of said steps or features.

### REFERENCES

1. C. Tanford, The Hydrophobic Effect. (Wiley, New York, 1980).
2. J. N. Israelachvili, Intermolecular and Surface Forces, Academic Press, 1992.
3. J. N. Israelachvili and R. M Pashley, Nature, 1982, 300, 341-343.
4. H. K. Christenson and P. M. Claesson, Adv. Coll. Int. Sci, 2001, 91(3), 391-436.
5. M. E. Karaman, B. W. Ninham and R. M. Pashley, J. Phys. Chem. 1996, 100, 15503-15507.
6. N. Ishida, M. Sakamoto, M. Miyahara and K. Higashitani, Langmuir, 2000, 16(13), 5681-5687.
7. R. M. Pashley, P. M. McGuiggan, B. W. Ninham and D. F. Evans Science, 229, 1088-1089 (1985).
8. R. M. Pashley, J. Phys. Chem. B, 2003, v 107, No 7, 1714-1720.
9. U.S. patent application Ser. No. 10/703,094 filed 5 Nov. 2003 and PCT/AU2004/001536 in the name of the present assignee.
10. N. Maeda, K. J. Rosenberg, J. N. Israelachvili and R. M. Pashley, Langmuir 2004, 20(8), 3129-3137.
11. R. G. Alargova, I. I. Kochijashky and R. Zana, Langmuir 1998, 14(7), 1575-1579.
12. M. L. Sierra and R. Zana, J. Coll. Int. Sci. 1999, 212(1), 162-166.
13. V. V. Yaminsky, V. S. Yushchenko, E. A. Amelina and E. D. Shchukin, J. Coll. Int. Sci. 1983, 96(2), 301-306.
14. K. G. Marinova, R. G. Alargova, N. D. Deiikov, O. D. Velev, D. N. Petsev, I. B. Ivanov and R. P. Borwankar, Langmuir, 1996, 12(8), 2045-2051.
15. M. S. L. Tai, I. Chua, K. Li, W. J. Ng and W. K. Teo. Journal of Membrane Science, 1994, 87(1-2), 99-105.
16. F. Wiesler, Ultrapure Water, March 2003, 38-42.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge.

1. A method of cleaning a surface, comprising applying water containing no more than 1 ppm gas to the surface to disperse or dissolve dirt on the surface in the water.

2. A method according to claim 1, wherein the water contains no more than about 0.9 ppm gas.

3. A method according to claim 1, wherein the water contains no more than about 0.3 ppm gas.

4. A method according to claim 1, wherein the water contains no more than about 3 ppb gas.

5. A method according to claim 1, wherein the water contains no more than about 0.3 ppb gas.

6. A method according to claim 1, wherein the surface is on an article and wherein the method comprises cleaning the article in the water in a container.

7. A method according to claim 6, wherein one or both of the article and water are agitated.

8. A method according to claim 1, wherein the water is applied to the surface by spraying.

9. A method according to claim 8, wherein the water is sprayed on to the surface by means of an airless spray system.

10. A method according to claim 1, which comprises applying multiple streams of the water to the surface to agitate dirt on the surface.

11. A method according to claim 1, wherein the water contains hydrophilic stabilising material to alleviate redeposition of the dirt on the surface.

12. A method according to claim 1, which comprises using a stored source of the water containing no more than 1 ppm gas.

13. A method according to claim 1, which includes de-gassing a source of water to a level of no more than 1 ppm gas.

14. A method according to claim 1, which comprises dissolving hydrophobic dirt on the surface using a non-aqueous solvent, and dispersing the non-aqueous solvent and dissolved hydrophobic dirt in the water.

15. A method according to claim 14, wherein the non-aqueous solvent is applied to the surface prior to applying the water to the surface.

16. A method according to claim 15, wherein the surface is relatively separated from a liquid body of the non-aqueous solvent prior to applying the water to the surface.

17. A method according to claim 14 wherein the non-aqueous solvent applied to the surface contains no more than about 10 ppm gas.

18. A method according to claim 17, wherein the non-aqueous solvent applied to the surface contains no more than about 1 ppm gas.

19. A method according to claim 17, wherein the non-aqueous solvent applied to the surface contains no more than about 0.3 ppm gas.

20. A method according to claim 17, wherein the non-aqueous solvent applied to the surface contains no more than about 3 ppb gas,

21. A method according to claim 17, wherein the non-aqueous solvent applied to the surface contains no more than about 0.3 ppb gas.

22. A method according to claim 17, which comprises using a stored source of the non-aqueous solvent containing no more than 10 ppm gas.

23. A method according to claim 17, which includes de-gassing the non-aqueous solvent to a level of no more than 10 ppm gas.

24. A method according to claim 14, wherein the non-aqueous solvent is hydrophobic.

25. A method according to claim 14, wherein the non-aqueous solvent is selected from hydrocarbons, fluorocarbons, chloro-hydrocarbons, silicone liquids and mixtures of one or more of same.

26. A method according to claim 25, wherein the non-aqueous solvent is selected from dodecane, squalene, hexamethyldisiloxane, perfluorohexane, hexane and mixtures of one or more of same.

27. Apparatus for cleaning a surface, comprising a source of water containing no more than 1 ppm gas and a dispenser for applying the water to the surface.

28. Apparatus according to claim 27, wherein the surface is on an article and the apparatus includes a container for receiving the article.

29. Apparatus according to claim 28, which includes an agitator for one or both of the article and water.

30. Apparatus according to claim 27, wherein the dispenser comprises a sprayer.

31. Apparatus according to claim 30, wherein the sprayer is part of an airless spray system.

32. Apparatus according to claim 27, wherein the dispenser applies multiple streams of the water to the surface to agitate dirt on the surface.

33. Apparatus according to claim 27, wherein the source of water comprises a store of the water containing no more than 1 ppm gas.

34. Apparatus according to claim 27, wherein the source of water comprises equipment for de-gassing water to a level of no more than 1 ppm gas.

35. Apparatus according to claim 27, which includes a source of non-aqueous solvent and a dispenser for applying the non-aqueous solvent to the surface.

36. Apparatus according to claim 35, wherein one dispenser is used for applying the water and the non-aqueous solvent.

37. Apparatus according to claim 35, wherein the source of the non-aqueous solvent comprises a store of the non-aqueous solvent.

38. Apparatus according to claim 35, wherein the source of nonaqueous solvent comprises equipment for de-gassing non-aqueous solvent to a level of no more than 10 ppm gas.
